(19) United States
(12) Patent Application Publication
(10) Pub. No.: US 2008/0175427 A1
(43) Pub. Date: Jul. 24, 2008

(54) PORTABLE SPEAKER APPARATUS AND SYSTEM

(76) Inventors: Shu Ting Chen, Shenzhen City (CN); Thomas A. Disco, Acworth, GA (US); Charles Scott Madison, Acworth, GA (US); Jin Wang, Kennesaw, GA (US); Bernard Goldfine, Kennesaw, GA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/951,235

(22) Filed: Dec. 5, 2007

Related U.S. Application Data
(60) Provisional application No. 60/873,206, filed on Dec. 6, 2006.

(51) Int. Cl. H04R 1/02

(52) U.S. Cl. 381/387; 381/386

(57) ABSTRACT

A portable system includes a hostable USB controller, USB decoder and speakers. The system operates to play audio files from external devices when powered.

### CROSS-REFERENCE TO RELATED APPLICATION

This utility application claims the benefit U.S. Provisional Application No. 60/873,206, filed on Dec. 6, 2006, which is incorporated herein by reference.

### BACKGROUND OF THE INVENTION

1. Field of the Invention

Exemplary embodiments relate generally to the technical field of speakers and, in one exemplary embodiment, to apparatus and systems of portable speakers.

2. Description of the Related Art

People typically listen to personal music players, such as MP3 players, with the use of headphones and earphones. When a person wants another person to hear audio sound from their personal music player, the other person has to put on the headphones or earphones. Speakers built in to personal music players cannot produce enough amplification to fill a room with sound.

### BRIEF DESCRIPTION OF THE DRAWINGS

Embodiments are illustrated by way of example and not by way of limitation in the figures of the accompanying drawings in which like references indicate similar elements. It should be noted that references to “an” embodiment in this disclosure are not necessarily to the same embodiment, and such a reference may mean at least one.

FIG. 1 illustrates a side view of an embodiment.

FIG. 2 illustrates a front view of an embodiment.

FIG. 3 illustrates a top view of an embodiment.

FIG. 4 illustrates a rear view of an embodiment.

FIG. 5 illustrates a circuit schematic of an embodiment.

FIG. 6 illustrates a block diagram of a host controller of an embodiment.

FIG. 7 illustrates a block diagram of a system of an embodiment.

FIG. 8 illustrates a portable audio player connected to an embodiment.

FIG. 9 illustrates a bottom view of an embodiment with a battery cover removed.

### DETAILED DESCRIPTION

An apparatus and system for playing audio are described. In the following description, for purposes of explanation, numerous specific details are set forth in order to provide a thorough understanding of an exemplary embodiment of the present invention. It will be evident, however, to one skilled in the art that the present invention may be practiced without these specific details.

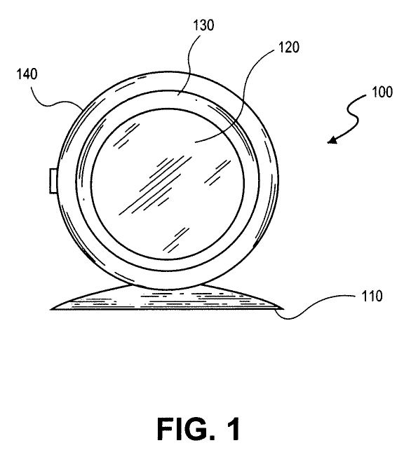

FIG. 1 illustrates a side view of an audio speaker system. In one embodiment, speaker system 100 has a tubular shape with speakers 120 on either end and a base support 110. In one embodiment speakers 120 have an aluminum thin film for acoustic clarity. Outer diaphragm 130 is attached to body 140 and allows travel of speakers 120. In one embodiment, body 140 is made of a metal or metal alloy. In one embodiment, body 140 is made of NiNi.

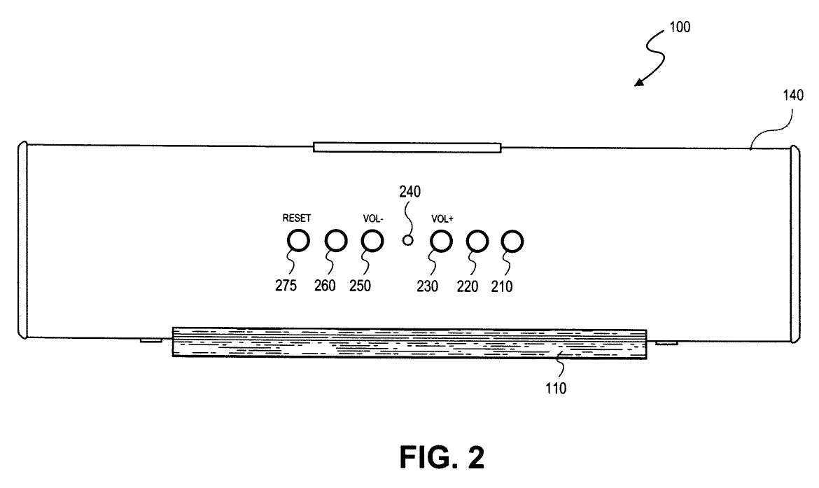

FIG. 2 illustrates a front view of speaker system 100. In this embodiment, control buttons or switches include reset 270, play/pause 260, volume decrease 250, power light 240, volume increase 230, previous 220 and next 210. In one embodiment reset 270 stops playing of audio files, such as MP3, MP4, etc. In another embodiment reset 270 allows repeat play or single loop play of all audio tracks. Play/pause 260 allows a user to alternate between playing of an audio file and pausing play. Volume decrease 250 decreases the audio play volume in preset increments. When volume decrease 250 is continuously pressed, the output volume will decrease until the volume is off. Power light 240 lights when speaker system 100 is powered on. In one embodiment power light 240 also lights when detecting data transferring. In one embodiment power light 240 is a colored LED. Volume increase 230 increases the audio play volume in preset increments. When volume increase 230 is continuously pressed, the output volume will increase until the volume is at the maximum volume. Previous 220 searches for a previous audio file to play. In one embodiment when speaker system 100 is playing a first audio file, previous 220 will reverse search from the bottom audio files when depressed. Next 210 searches for the next audio file to play. In one embodiment when speaker system 100 is playing the last audio file, next 210 will search from the beginning audio files when depressed.

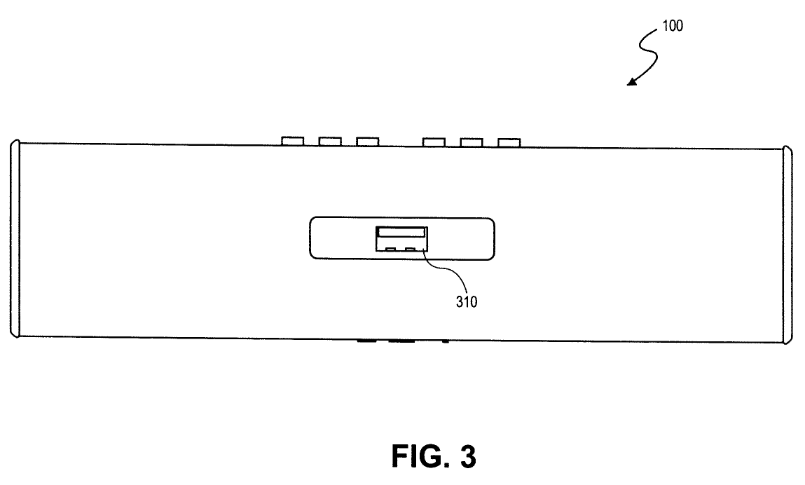

FIG. 3 illustrates a top view of speaker system 100. Audio data input interface 310 (i.e., USB port) allows for an external USB device (USB 1.1, USB2.0) flash disk or MP3/MP4 playing devices, such as the iPod®) to be directly or indirectly plugged into speaker system 100.

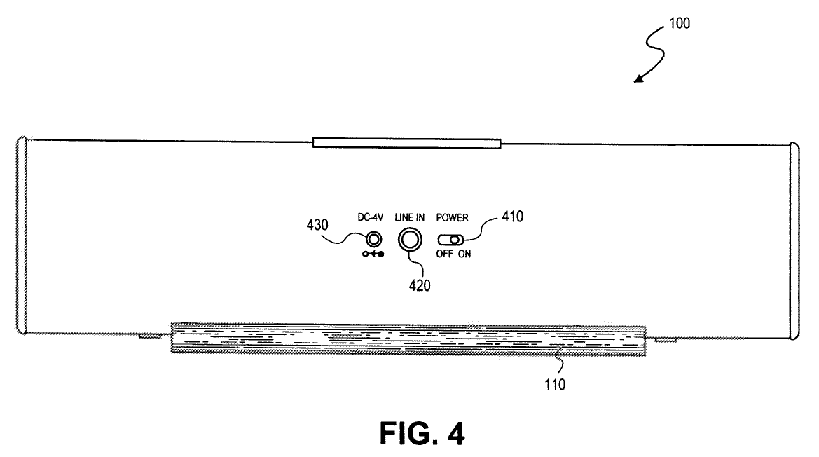

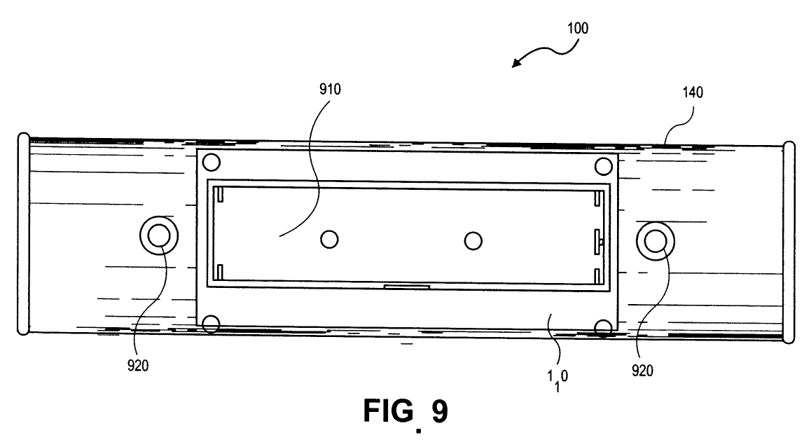

FIG. 4 illustrates a rear view of speaker system 100. Speaker system 100 includes power switch 410, line in interface 420 and power adapter interface 430. In one embodiment line in interface 420 is a standard stereo plug (e.g., 3.5 mm) for inputting external lines to speaker system 100. Power adapter interface 430 allows plugging in of an AC/DC adapter. In one embodiment, speaker system 100 requires 6V, which can be input by power adapter interface 430. Alternatively, a USB cable or batteries inserted through base support 110 (see FIG. 9) can be used to power speaker system 100 (e.g., 4 AAA).

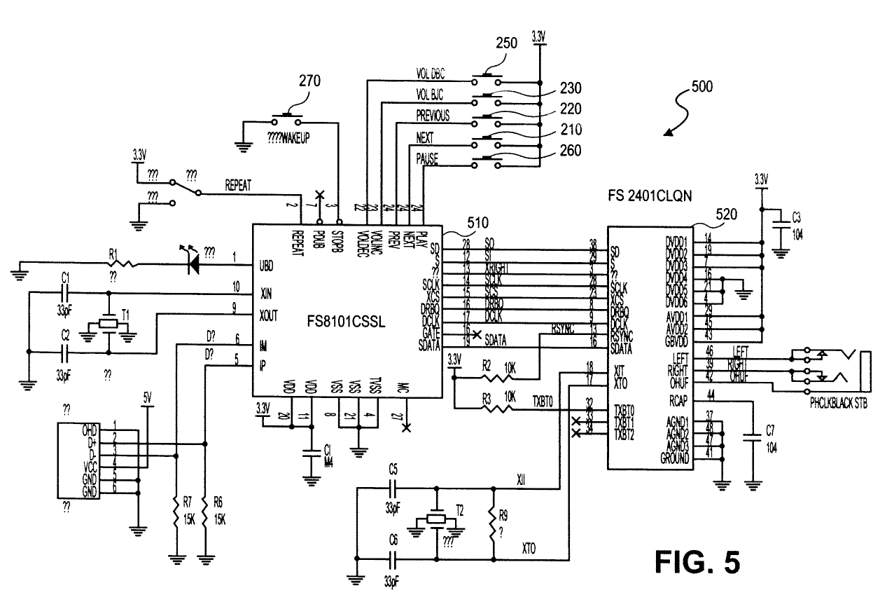

FIG. 5 illustrates an internal circuit 500 diagram for one embodiment of speaker system 100. In one embodiment hostable MCU 510 is a USB 1.1 hostable controller for USB1.1/USB 2.0 flash disk devices with mass storage class. Hostable MCU 510 supports USB devices to host data transfer for read only and USB host mass storage (SCSI and SFF-8070i) file management (e.g., MP3/WAV/WMA/MIDI, etc.) firmware. In one embodiment hostable MCU 510 supports flash file system (FAT 16/FAT 32) for 32 MB and above. In one embodiment, when a USB device is plugged into audio data interface 310 (i.e., USB port) hostable MCU 510 searches for and reads MP3 files from the USB device. The data is then sent to decoder 520.

Decoder 520 decodes audio files transferred by hostable MCU 510. Decoder 520 decodes MPEG ½ audio layer 3, WAV, PCM, etc. In one embodiment decoder 520 samples at a 48 Khz/44.1 Khz with a bit rate of 32 kb/s˜320 kb/s. In one embodiment decoder 520 supports variable bit rate for MP3 and 18 bit DAC. Decoder 520 includes a stereo earphone driver for driving a 30-load output.

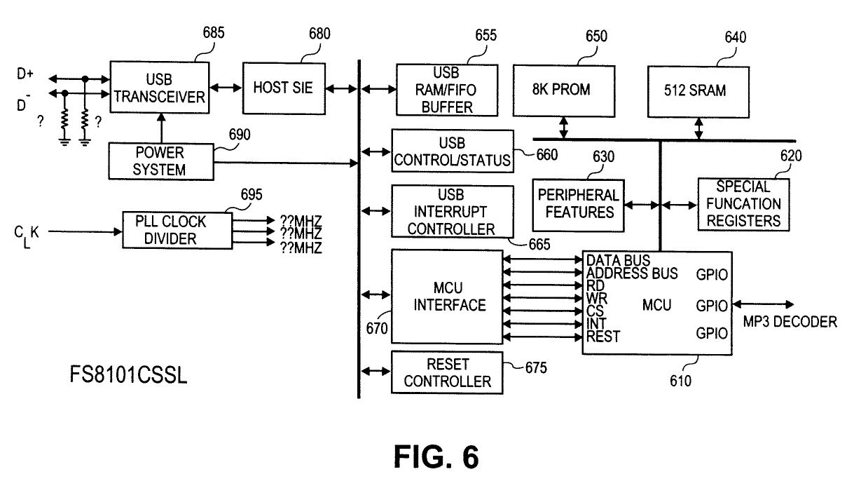

FIG. 6 illustrates a functional block diagram of hostable MCU 510. The functional blocks shown are as follows: USB transceiver 685, host SIE 680, power system 690, PLL clock divider 695, USB RAM/FIFO buffer 655, 8K PROM 650, 512 SRAM 640, USB control/status 660, USB interrupt controller 665, peripheral features 630, special function registers 620, MCU interface 670, MCU 610 and reset controller 675.

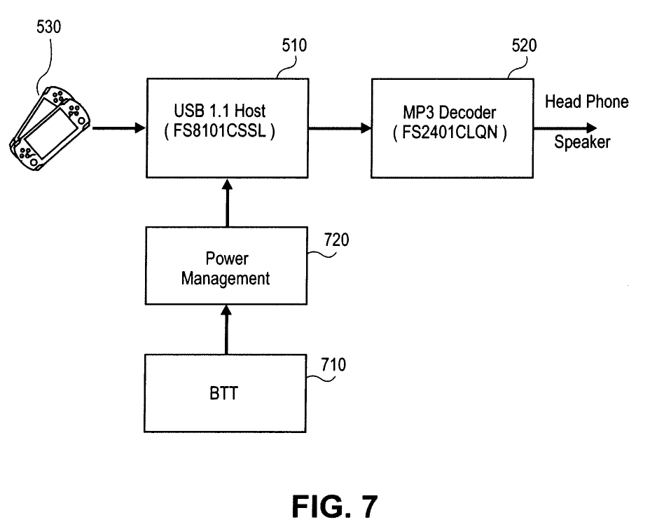

FIG. 7 illustrates a block diagram of internal circuit 500. As illustrated a USB device 530 player connects to hostable MCU 510. BTT 710 is connected to Power management 720 controls and distributes power to hostable MCU 510. Hostable MCU 510 transfers data received from USB device 530 to be decoded by decoder 520. Decoder 520 transmits the decoded audio to a headphone or speakers 120.

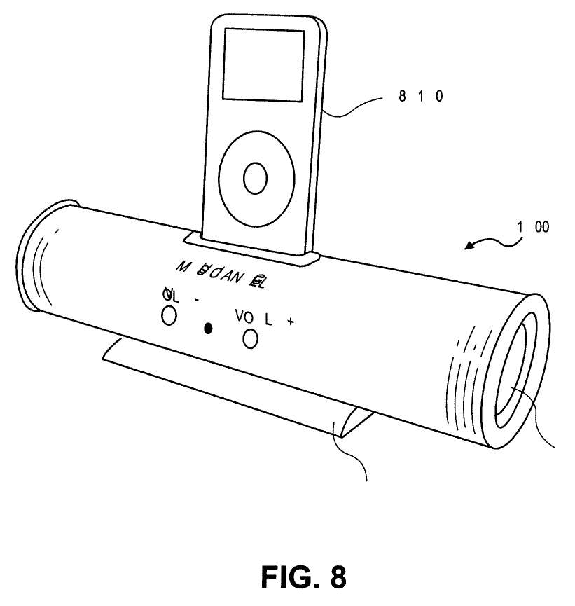

FIG. 8 illustrates a perspective view of speaker system 100 with a USB audio playing device 810 inserted into audio data input interface 310. FIG. 9 illustrates a bottom view of speaker system 100 with a battery cover removed from base support 110. As shown, battery compartment 910 holds batteries to power speaker system 100 (e.g., 4 AAA). Air holes 920 push air out of body 140 when speakers 120 travel in and out when an audio file is being played.

In one embodiment speaker system 100 outputs a total of 4 W (2 W+2 W) with total harmonic distortion (THD) of 10% or less. In one embodiment the frequency response is 150-18000 HZ (+/−3 dB). The signal to noise ration for one embodiment is ≧80 dB. In one embodiment speakers 120 have an external diameter of 40 mm and have a magnetic resistance of 40 hms. In one embodiment speaker system 100 can be integrated with devices such as LCDs, DVD players, computers (e.g., lap top computers), personal digital assistants (PDAs), other MP3 players, portable gaming devices, cellular telephones, etc. to increase sound performance. In one embodiment speaker system 100 produces crystal clear sound with crisp highs and deep full bass sounds. Hostable MCU 510 and decoder 520 allow users to play louder sound without having to download additional software, which makes speaker system 100 a plug and play type of device. Since speaker system 100 is portable, speaker system 100 can be used wherever a person takes their audio device to integrate with speaker system 100.

Thus, an apparatus and system for portable playing of audio files through speaker system 100 have been described. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

What is claimed is:

1. An apparatus comprising:
a tubular housing;
a plurality of speakers disposed in the tubular housing;
a docking port coupled to the tubular housing; and
a controller circuit disposed within the tubular housing; wherein the docking port is adapted to connect with an audio player.

2. The apparatus of claim 1, further comprising a battery compartment and a DC coupling port.

3. The apparatus of claim 1, wherein the docking port is adapted to couple with one of a USB device and a MP3/MP4 device.

4. The apparatus of claim 1, wherein the controller circuit includes an audio file decoder and a multipoint control unit (MCU).

5. The apparatus of claim 1, wherein the controller circuit includes a power management module.

6. The apparatus of claim 1, wherein the tubular housing is made of a metal.

7. The apparatus of claim 1, wherein the docking port is adapted to couple with one of a PDA, DVD player, portable gaming device, a cellular telephone and MP3/MP4 players.

8. The apparatus of claim 1, wherein the controller circuit includes an amplifier.

9. The apparatus of claim 1, wherein the apparatus is a portable speaker device.

10. A tubular speaker system comprising:
a tubular housing;
a first speaker and a second speaker disposed at opposite ends of the tubular housing;
an audio data input interface coupled on a first portion of the tubular housing;
an audio play control circuit coupled within the tubular housing; and
an amplification module disposed within the tubular housing, wherein the tubular speaker system is adapted to couple with a device to play audio files.

11. The tubular speaker system of claim 10, further comprising a power management module coupled to the amplification module.

12. The tubular speaker device of claim 10, further comprising a memory device coupled to the audio play control circuit.

13. The tubular speaker system of claim 10, further comprising an audio file decoder including a stereo earphone driver.

14. The tubular speaker system of claim 10, wherein the tubular speaker system is powered by one of at least one battery and an AC/DC adapter.

15. The tubular speaker system of claim 10, wherein the tubular speaker system is powered through a USB cable.

16. The tubular speaker device of claim 10, wherein the tubular housing is made of NiNi.

17. A portable speaker system comprising:
a tubular body made of a metal;
a first speaker and a second speaker disposed at opposite ends of the tubular body;
a sound control module coupled to the first speaker and the second speaker; and
an audio device docking port adapted to couple with an external audio player,
wherein the portable speaker system amplifies sound from audio files first stored on an external audio player.

18. The portable speaker system of claim 17, further comprising a memory device and an audio file management module.

19. The portable speaker system of claim 17, wherein an external audio player couples to the portable speaker system one of directly and indirectly.

20. The portable speaker system of claim 17, further comprising a hostable MCU device coupled to the sound control module.
